(19) United States
(12) Patent Application Publication
(10) Pub. No.: US 2014/0013268 A1
(43) Pub. Date: Jan. 9, 2014

(54) METHOD FOR CREATING A SCRIPTED EXCHANGE

(71) Applicant: Eric Foster WHITE, Littleton, CO (US)

(72) Inventor: Eric Foster WHITE, Littleton, CO (US)

(73) Assignee: Mobitude, LLC, a Delaware LLC, Littleton, CO (US)

(21) Appl. No.: 13/544,905

(22) Filed: Jul. 9, 2012

(51) Int. Cl. G06F 3/048

(52) U.S. Cl. 715/780

(57) ABSTRACT

A system for generating a scripted exchange. A user specifies first content with a first source, a time delay (or an absolute time) and second content with a second source. The first content is shown associated with the first source. After an elapsed time equal to the delay (or at the specified absolute time), the second content is shown associated with the second source. The first and second source may be the same. Additional entries associated with the same or other sources may be similarly specified, generating the scripted exchange.

### BACKGROUND

Entertainment is traditionally produced for media such as television, movies, albums, music videos, etc. In recent years, the public has adopted new media for exchanging information, such as SMS texting, chats, blogs, tweets, postings on social networks, etc. Such exchanges are factual and real-time. For example, a message is sent as soon as it is created by the person or entity identified as its sender. A response to such a message is generated by the recipient only after reading and considering the received message. The response is sent as soon as it is created.

Existing real-time message exchange systems are inadequate for entertainment purposes. An exchange between characters in an entertainment production over these new media can only be produced in real-time, as described above. This may not be desirable, as the actual time at which messages are exchanged between characters may have to be carefully timed and repeatedly sent to different recipients based upon the storyline. With existing systems, the actors or their proxies would have to generate and send messages each time in the right order and with the correct timing for the exchange to support the storyline.

### BRIEF SUMMARY

According to an embodiment of the disclosed subject matter, a computer-implemented method comprises presenting a user interface having a first entry field, a second entry field, a presentation time entry field, and a first time delay entry field. A first source is associated with the first entry field and a second source is associated with the second entry field. The method further comprises receiving a first content in the first entry field, receiving a first time delay value in the first time delay entry field, receiving a second content in the second entry field, and receiving a presentation time in the presentation time entry field. Further, the method includes storing a scripted exchange that comprises the first content, the first time delay, the second content, and the presentation time. Additionally, the method comprises receiving a request for the scripted exchange from a system adapted and configured to cause the first content to be displayed at the presentation time and the second content to be displayed after the presentation time by an amount of time equal to the first time delay.

In accordance with an embodiment of the disclosed subject matter, a system comprises a computer-readable medium and a processor. The processor is configured to present a user interface including a first entry field, a second entry field, and a first time delay entry field. A first source identifier may be received, which is associated with the first entry field and a second source identifier may be received, which is associated with the second entry field. The processor is further configured to receive a first content in the first entry field, receive a first time delay value in the first time delay entry field, receive a second content in the second entry field, and receive a presentation time. Further, a scripted exchange that comprises the first content, the first time delay value, the second content, and the presentation time is stored at the computer-readable medium.

Additional features, advantages, and embodiments of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a system according to an embodiment of the disclosed subject matter.

FIG. 2 shows a system according to an embodiment of the disclosed subject matter.

FIG. 3 shows a computer according to an embodiment of the disclosed subject matter.

FIG. 4 shows a network configuration according to an embodiment of the disclosed subject matter.

FIG. 5 shows an exchange of information between an author and a content management system in accordance with an embodiment of the disclosed subject matter.

### DETAILED DESCRIPTION

Embodiments of the disclosed subject matter can enable the creation of a scripted chat exchange between characters or cast members, simulating a real-time conversation. Using a content management system, a scripted exchange may be created and scheduled to be displayed to a viewer at a specified day and time. The scripted exchange can include a plurality of scripted messages and at least one source (e.g., character name, cast member, etc.) associated with each message. The scripted exchange may also include a time delay associated with each message causing the message to be displayed at a time equal to the time delay value after the start of the scripted chat exchange, or after a previously displayed message.

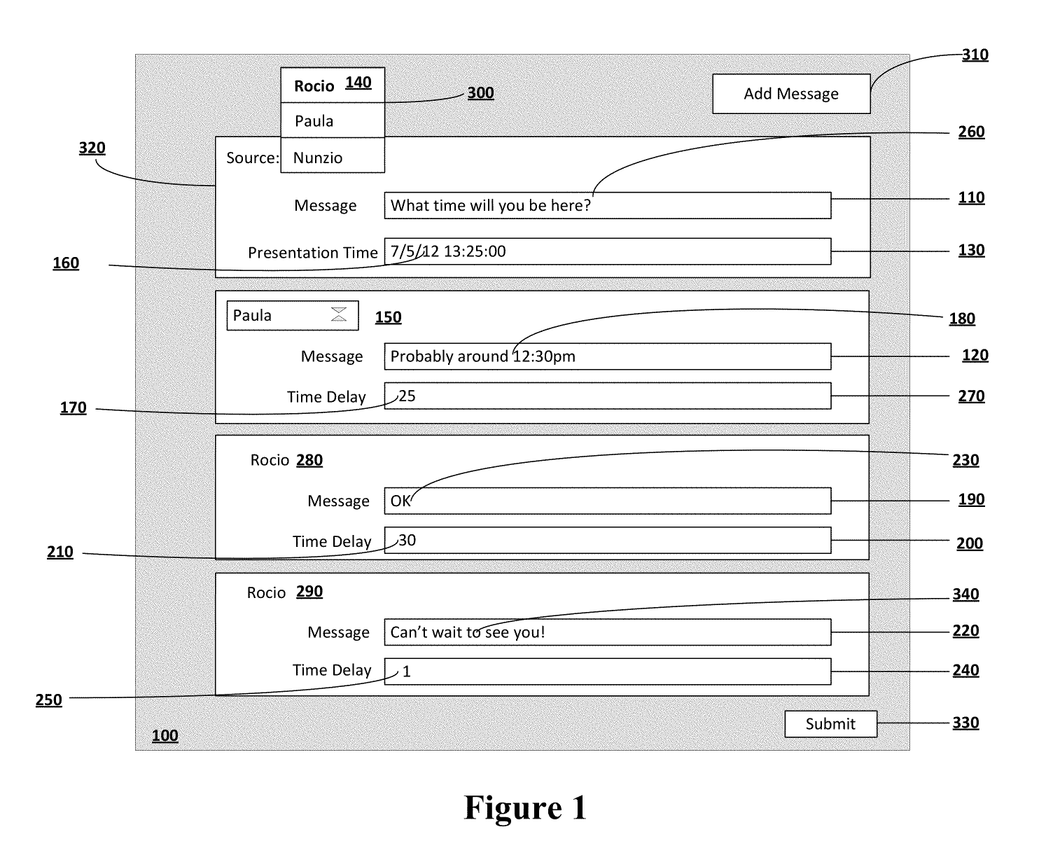

FIG. 1 shows a system in accordance with the disclosed subject matter. A method for creating a scripted exchange may include presenting a user interface 100 having a button 310 or other graphical element for receiving a request to add a message entry box 320. A message entry box 320 may include a message entry field (such as 110,120,190, or 220), a presentation time entry field 130, a time delay entry field (such as 270,200,240), and source designation field 300. A message entry field can receive the contents of a message to be displayed to a user in accordance with the disclosed subject matter. The presentation time entry field 130 can receive a presentation time 160 (such as the date and time) at which the message 260 is to be displayed to the user. The time delay entry field 270 can receive a relative time delay value 170 to display the message 180. For example, the time delay field 270 can receive a value 170 in seconds after a previous message at which to display a current message 180. The source selection designator can include a mechanism (e.g., a drop down menu, search-as-you-type box, etc.) for specifying the identity of the sender to be associated with a given message.

When an author wishes to add another message to the set of messages to be displayed to the viewer, the author can select the add message button 310, which can cause another message entry box 320 to appear. When the author has completed creating the set of messages to be displayed to the viewer, the author can select the submit button 330, which can cause the entered messages to be stored as a set of messages.

A source 140 may be associated with the message entry field 110 and another source 150 may be associated with another message entry field 120. For example, Rocio 140 can be associated with the first message 260 and Paula 150 can be associated with the second message 180 which can be a response to Rocio's message. Content for the first message 260 may be received in the first entry field 110 and content for the second message 180 may be received in the second entry field 120. Content can include text, video, audio, an image, a picture, etc. A presentation time 160 may be received in the presentation time entry field 130. For example, the first message can be scheduled to be displayed to a viewer on Jul. 5, 2012 at 1:25 pm. A time delay value 170 may be received in the time delay entry field 270. An example of a scripted exchange can include the first content 260, the first time delay value 170, the second content 180, and the presentation time 160. The scripted exchange may be stored in a database, in a flat file, on a hard disk, in RAM, etc. The scripted exchange may also include the first source 140 and the second source 150. A request for the scripted exchange may be received from a system capable of causing the first content 260 to be displayed at the presentation time 160 and the second content 180 to be displayed after the presentation time 160 by an amount of time equal to the first time delay value 170.

The presentation time 160 may include a date, time, time zone, day, etc. The presentation time entry field 130 may include a single field for receiving a presentation time 160. The presentation time entry field 130 may also include multiple separate fields for receiving a date, a time, a time zone, a day, etc. A time delay value 170 may be a value of time, such as, milliseconds, seconds, minutes, hours, etc. Additionally, the presentation time 160 and time delay value 170 may be a SMPTE timecode or other time reference standard.

Further, the user interface 100 may include a third entry field 190 and a second time delay entry field 200. A third source 280 may be associated with the third entry field 190. The third source 280 and the first source 140 may be the same. A third message content 230 may be received in the third entry field 190 and a second time delay value 210 may be received in the second time delay entry field 200. A fourth message content 340 may be received in the fourth entry field 220 and a third time delay value 250 may be received in the third time delay entry field 240. Additionally, the scripted exchange as discussed above may also include the third content 230, the second time delay value 210, the fourth content 340, and the third time delay value 250. A presentation time entry field 130 and a time entry delay field 270 may be interchangeable. The time at which any message is to be displayed may be specified as an absolute time (e.g., a presentation time) or a relative time (e.g., a delay time).

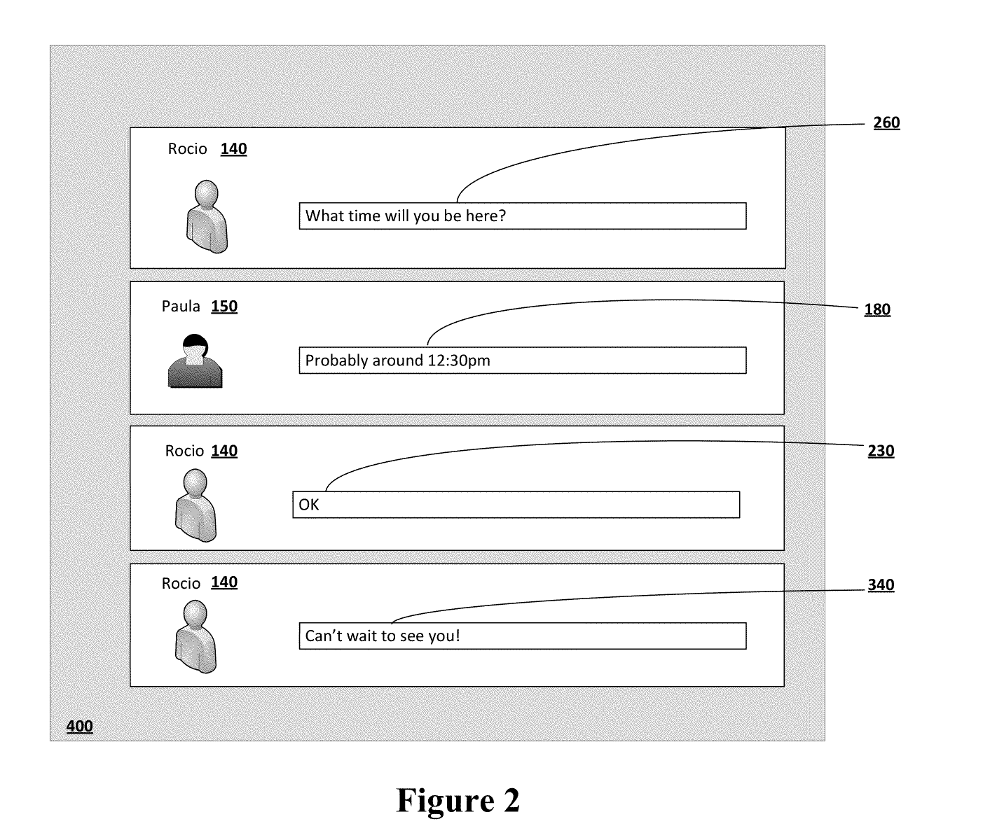

FIG. 2 shows a system in accordance with the disclosed subject matter. The scripted exchange 400 may be displayed to a user. The scripted exchange 400 may begin with display of the first message 260 on Jul. 5, 2012 at 1:25 pm. Twenty-five seconds later, the second message 180 may appear. Thirty seconds thereafter, the third message 230 may appear and one second later the fourth message 340 may appear, etc. The scripted exchange can thus simulate a real-time chat exchange. In other implementations, the second time delay 210 (e.g., thirty seconds) can be relative to the presentation time 160 rather than the time that the last message was displayed. For example, the second message 180 can be presented twenty-five seconds after 1:25 pm and the third message 230 can be displayed thirty seconds after 1:25 pm, i.e., five seconds after the previous message. Likewise, the third message 230 can be associated with an absolute presentation time, e.g., 1:26:17, i.e., one minute and seventeen seconds after the first message 260 is displayed. The message content 260,180,230,340 can include text, video, audio, an image, a picture, etc.

As discussed above, a source 140,150,280,290 may be selected from a drop down menu 300. A source 140,150,280,290 may be text, a picture, an image, an icon, a video, a sound, etc., or any combination thereof. A source 140,150,280,290 may be associated with an actor, a person, a fictional character, a television personality, a celebrity, a public persona, etc. In addition, the first and second sources 140,150 may be the same, the first and third sources 140,280 may be the same, the second and third sources 150,280 may be the same, and the first, second, third, and fourth sources 140,150,280,290 may be the same, etc.

In an embodiment of the disclosed subject matter, the scripted exchange may be sent to a user via SMS text message. For example, each message in the scripted exchange may be displayed on a user's mobile device, such as a smartphone. For example, the scripted exchange 400 may begin with sending the first message 260 to a user's smartphone via SMS text message, at the presentation time 160, on Jul. 5, 2012 at 1:25 pm. Twenty-five seconds later, the second message 180 may be sent as a text message to the user's smartphone. Thirty seconds thereafter, the third message 230 may be sent and one second later the fourth message 340 may be sent, etc. The scripted exchange can thus simulate a real-time exchange via text message on a user's mobile device. Embodiments of the presently disclosed subject matter can be used with any message exchange protocol, such as instant messaging, notifications, alerts, etc.

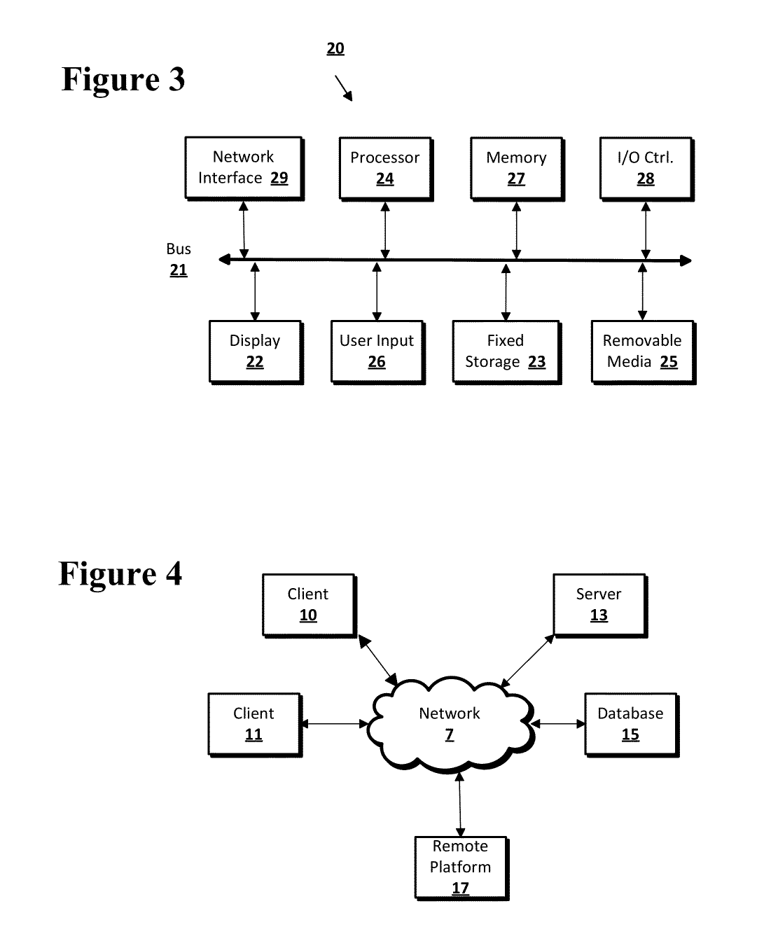

Embodiments of the presently disclosed subject matter may be implemented in and used with a variety of component and network architectures. FIG. 3 is an example computer 20 suitable for implementing embodiments of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 4.

Many other devices or components (not shown) may be connected in a similar manner (e.g., document scanners, digital cameras and so on). Conversely, all of the components shown in FIG. 3 need not be present to practice the present disclosure. The components can be interconnected in different ways from that shown. The operation of a computer such as that shown in FIG. 3 is readily known in the art and is not discussed in detail in this application. Code to implement the present disclosure can be stored in computer-readable storage media such as one or more of the memory 27, fixed storage 23, removable media 25, or on a remote storage location.

FIG. 4 shows an example network arrangement according to an embodiment of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

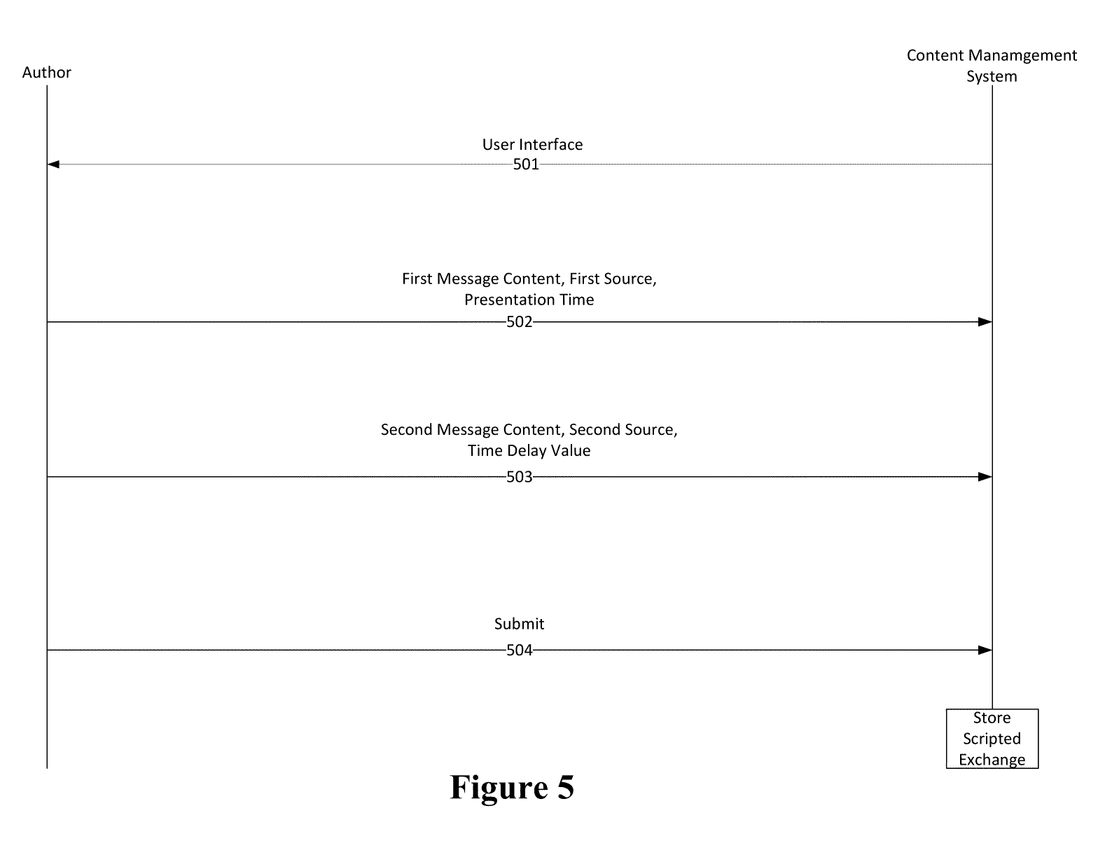

An implementation of the disclosed subject matter is shown in FIG. 5. A content management system provides a user interface 501 to an author. The author provides a first message content, a first source, and a presentation time 502 to the content management system. The author may also provide a second message content, a second source, and a time delay value 503 to the content management system. The author may provide additional messages, sources, and absolute or relative presentation times (not shown). When the author has completed authoring the scripted exchange, the author can cause the content management system to store the exchange by selecting a submit button 504.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method comprising:
presenting a user interface having a first entry field, a second entry field, a presentation time entry field, and a first time delay entry field;
associating a first source with the first entry field;
associating a second source with the second entry field;
receiving a first content in the first entry field;
receiving a first time delay value in the first time delay entry field;
receiving a second content in the second entry field;
receiving a presentation time in the presentation time entry field;
storing a scripted exchange that comprises the first content, the first time delay, the second content, and the presentation time;
receiving a request for the scripted exchange from a system adapted and configured to cause the first content to be displayed at the presentation time and the second content to be displayed after the presentation time by an amount of time equal to the first time delay.

2. The method of claim 1, wherein the user interface further comprises a third entry field and a second time delay entry field.

3. The method of claim 2, further comprising:
associating a third source with the third entry field;
receiving a third content in the third entry field;
receiving a second time delay value in the second time delay entry field;
wherein the scripted exchange further comprises the third content and the second time delay.

4. The method of claim 3, wherein the system is further adapted and configured to cause the third content to be displayed after the presentation time by an amount of time equal to the second time delay value.

5. The method of claim 3, wherein the system is further adapted and configured to cause the third content to be displayed after the second content at a time equal to the sum of the first time delay value and the second time delay value.

6. The method of claim 1, wherein the first source and the second source are the same.

7. The method of claim 1, wherein the scripted exchange further comprises the first source and the second source.

8. The method of claim 3, wherein the first source and the third source are the same.

9. The method of claim 3, wherein the second source and the third source are the same.

10. The method of claim 1, wherein the first content comprises at least one selected from the group of text, video, audio, an image, and a picture.

11. The method of claim 1, wherein the second content comprises at least one selected from the group of text, video, audio, an image, and a picture.

12. The method of claim 1, wherein the first source is at least one selected from the group of an actor, a person, a fictional character, a television personality, a celebrity, and a public persona.

13. The method of claim 1, wherein the second source is at least one selected from the group of an actor, a person, a fictional character, a television personality, a celebrity, and a public persona.

14. The method of claim 1, wherein the presentation time includes a date and time.

15. The method of claim 3, wherein the third content comprises at least one selected from the group of text, video, audio, an image, and a picture.

16. The method of claim 3, wherein the third source is at least one selected from the group of an actor, a person, a fictional character, a television personality, a celebrity, and a public persona.

17. A system, comprising:
a computer-readable medium;
a processor configured to:
present a user interface including a first entry field, a second entry field, and a first time delay entry field;
receive a first source identifier associated with the first entry field;
receive a second source identifier associated with the second entry field;
receive a first content in the first entry field;
receive a first time delay value in the first time delay entry field;
receive a second content in the second entry field;
receive a presentation time, and
store a scripted exchange that comprises the first content, the first time delay value, the second content, and the presentation time at the computer-readable medium.

18. The system of claim 17, wherein the processor is further configured to receive a request for the scripted exchange from a system adapted and configured to cause the first content to be displayed at the presentation time and the second content to be displayed after the presentation time by an amount of time equal to the first time delay value.

19. The system of claim 18, wherein the user interface further comprises a third entry field and a second time delay entry field.

20. The system of claim 19, wherein the processor is further configured to:
receive a third source identifier associated with the third entry field;
receive a third content in the third entry field;
receive a second time delay value in the second time delay entry field;
wherein the scripted exchange further comprises the third content and the second time delay value.

21. The system of claim 20, wherein the system is further adapted and configured to cause the third content to be displayed after the presentation time by an amount of time equal to the second time delay value.

22. The system of claim 20, wherein the system is further adapted and configured to cause the third content to be displayed after the second content at a time equal to the sum of the first time delay value and the second time delay value.

23. The system of claim 17, wherein the first source identifier and the second source identifier are the same.

24. The system of claim 17, wherein the scripted exchange further comprises the first source and the second source.

25. The system of claim 20, wherein the first source identifier and the third source identifier are the same.

26. The system of claim 20, wherein the second source identifier and the third source identifier are the same.

27. The system of claim 17, wherein the first content comprises at least one selected from the group of text, video, audio, an image, and a picture.

28. The system of claim 17, wherein the second content comprises at least one selected from the group of text, video, audio, an image, and a picture.

29. The system, of claim 17, wherein the first source identifier is at least one selected from the group of an actor, a person, a fictional character, a television personality, a celebrity, and a public persona.

30. The system of claim 17, wherein the second source identifier is at least one selected from the group of an actor, a person, a fictional character, a television personality, a celebrity, and a public persona.

31. The system of claim 17, wherein the presentation time includes a date and time.

32. The system of claim 20, wherein the third content comprises at least one selected from the group of text, video, audio, an image, and a picture.

33. The system of claim 20, wherein the third source identifier is at least one selected from the group of an actor, a person, a fictional character, a television personality, a celebrity, and a public persona.
